(19) United States
(12) Patent Application Publication
(10) Pub. No.: US 2023/0318334 A1
(43) Pub. Date: Oct. 5, 2023

(54) CONTROL APPARATUS, CONTROL METHOD, AND PROGRAM

(71) Applicant: HONDA MOTOR CO., LTD., Tokyo (JP)

(72) Inventors: Takako Sato, Wako-shi (JP); Hirotaka Nakagawa, Wako-shi (JP); Sae Shinjo, Wako-shi (JP); Atsushi Tamai, Wako-shi (JP); Hanzhi Yang, Wako-shi (JP); Junji Kuwabara, Wako-shi (JP); Yusuke Kawano, Tokyo (JP); Masafumi Shiwa, Wako-shi (JP); Yurika Nishimoto, Wako-shi (JP)

(21) Appl. No.: 18/125,838

(22) Filed: Mar. 24, 2023

(30) Foreign Application Priority Data
Mar. 29, 2022 (JP) 2022-053208

(51) Int. Cl. H02J 7/00

(52) U.S. Cl. CPC H02J 7/0048

(57) ABSTRACT

A control apparatus controls a charging device that is connected to a secondary battery having a negative electrode which is a mixture of graphite and silicon monoxide and supplies a current to the secondary battery, wherein when a calculated SOC (State of Charge) of the secondary battery is less than 15%, a magnitude of the current supplied to the secondary battery by the charging device is controlled to a first value, and when the calculated SOC of the secondary battery is equal to or more than 15%, the magnitude of the current supplied to the secondary battery by the charging device is controlled to a second value that is larger than the first value.

### CROSS-REFERENCE TO RELATED APPLICATION

Priority is claimed on Japanese Patent Application No. 2022-053208, filed on Mar. 29, 2022, the contents of which are incorporated herein by reference.

### BACKGROUND

### Field of the Invention

The present invention relates to a control apparatus, a control method, and a program.

### Background

A multi-stage charging method is known which changes the magnitude of a current when charging a secondary battery. By using the multi-stage charging method, it is possible to reduce the degradation of a battery at the time of rapid charging and extend the life of the battery (as related documents, refer to, for example, PCT International Publication No. 2015/163017, and Japanese Unexamined Patent Application, First Publication No. 2015-12680).

### SUMMARY

However, techniques are required which can improve the multi-stage charging method of the related art and obtain a higher charging amount.

An object of an aspect of the present invention is to provide a control apparatus of a charging device, a control method, and a program capable of obtaining a higher charging amount at the time of rapid charging. Further, it is possible to improve energy efficiency by obtaining a higher charging amount.

A first aspect of the present invention is a control apparatus for controlling a charging device that is connected to a secondary battery having a negative electrode which is a mixture of graphite and silicon monoxide and supplies a current to the secondary battery, wherein when a calculated SOC (State of Charge) of the secondary battery is less than 15%, a magnitude of the current supplied to the secondary battery by the charging device is controlled to a first value, and when the calculated SOC of the secondary battery is equal to or more than 15%, the magnitude of the current supplied to the secondary battery by the charging device is controlled to a second value that is larger than the first value.

A second aspect is the control apparatus according to the first aspect described above, wherein when a magnitude of a current that charges a rating capacity of the secondary battery in one hour is set to 1C, the first value may be equal to or less than C/3, and the second value may be equal to or more than 2C.

A third aspect of the present invention is a control method in which a computer controls a charging device that is connected to a secondary battery having a negative electrode which is a mixture of graphite and silicon monoxide and supplies a current to the secondary battery, the control method including: controlling a magnitude of the current supplied to the secondary battery by the charging device to a first value when a calculated SOC (State of Charge) of the secondary battery is less than 15%; and controlling the magnitude of the current supplied to the secondary battery by the charging device to a second value that is larger than the first value when the calculated SOC of the secondary battery is equal to or more than 15%.

A fourth aspect of the present invention is a computer-readable non-transitory storage medium which includes a program causing a computer to control a charging device that is connected to a secondary battery having a negative electrode which is a mixture of graphite and silicon monoxide and supplies a current to the secondary battery, the program causing the computer to execute: controlling a magnitude of the current supplied to the secondary battery by the charging device to a first value when a calculated SOC (State of Charge) of the secondary battery is less than 15%; and controlling the magnitude of the current supplied to the secondary battery by the charging device to a second value that is larger than the first value when the calculated SOC of the secondary battery is equal to or more than 15%.

According to the first to fourth aspects described above, it is possible to obtain a higher charging amount at the time of charging of a secondary battery.

### BRIEF DESCRIPTION OF THE DRAWINGS

FIG. 1 is a view showing a charging system according to an embodiment.

FIG. 2 is a view showing a transition example of a SOC of a secondary battery.

FIG. 3 is a flowchart showing an operation of the charging system.

FIG. 4 is a graph showing a control method of the embodiment.

FIG. 5 is a graph showing a control method of the related art.

FIG. 6 is a view showing a charging amount in the control method of the related art.

FIG. 7 is a view showing a charging amount in the control method of the embodiment.

### DESCRIPTION OF EMBODIMENTS

Hereinafter, an embodiment of a control apparatus, a control method, and a program of the present invention will be described with reference to the drawings.

FIG. 1 is a view showing a charging system 1 according to the present embodiment.

The charging system 1 includes a secondary battery 10, a charging device 20, a SOC calculation device 30, and a control apparatus 40.

A current is supplied to the secondary battery 10, and thereby, the secondary battery 10 is charged. The secondary battery 10 has a positive electrode and a negative electrode. The positive electrode is, for example, LiNi_{0.5}Co_{0.2}Mn_{0.3}O₂ (NCM523), LiNi_{0.6}Co_{0.2}Mn_{0.2}O₂ (NCM622), or LiNi_{0.8}Co_{0.1}Mn_{0.1}O₂ (NCM811) but is not limited thereto. The negative electrode is a mixture of graphite and silicon monoxide (SiO). The secondary battery 10 may include a battery sensor that detects a current value, a voltage value, and a temperature of the secondary battery 10.

The charging device 20 is connected to the secondary battery 10 and charges the secondary battery 10. The charging device 20, for example, supplies a current to the secondary battery 10 and thereby charges the secondary battery 10. The magnitude of the current supplied by the charging device 20 is controlled by the control apparatus 40 described later.

The SOC calculation device 30 calculates an SOC (State Of Charge; battery charging rate) of the secondary battery 10. The SOC calculation device 30 acquires, for example, detection information from the battery sensor provided on the secondary battery and calculates the SOC of the secondary battery 10. The SOC calculation device 30 may include a sensor that detects a current value, a voltage value, and a temperature of the secondary battery 10, may be connected to the secondary battery 10 and detect the current value, the voltage value, and the temperature of the secondary battery 10, and may thereby calculate the SOC of the secondary battery 10. The calculated SOC of the secondary battery 10 may be a charging amount of the secondary battery 10. The SOC calculation device 30 outputs the calculated SOC of the secondary battery 10 to the control apparatus 40.

The control apparatus 40 controls the charging device 20 on the basis of the SOC of the secondary battery 10 and thereby controls the magnitude of the current supplied to the secondary battery 10 by the charging device 20. The control apparatus is realized by, for example, a hardware processor such as a CPU (Central Processing Unit) executing a program (software). Some or all of the control apparatus may be realized by hardware (a circuit unit including circuitry) such as a LSI (Large-Scale Integration), an ASIC (Application-Specific Integrated Circuit), a FPGA (Field-Programmable Gate Array), and a GPU (Graphics-Processing Unit), or may be realized by software and hardware in cooperation. The program may be stored in advance in a storage device (a storage device including a non-transitory storage medium) such as a HDD (Hard Disk Drive) or a flash memory, or may be stored in a detachable storage medium (a non-transitory storage medium) such as a DVD or a CD-ROM and installed by the storage medium being attached to a drive device.

The control apparatus 40 controls the magnitude of the current supplied to the secondary battery 10 by the charging device 20 to a first value when the SOC of the secondary battery 10 is less than 15%, and controls the magnitude of the current supplied to the secondary battery 10 by the charging device 20 to a second value when the SOC of the secondary battery 10 is equal to or more than 15%. The second value is a larger value than the first value.

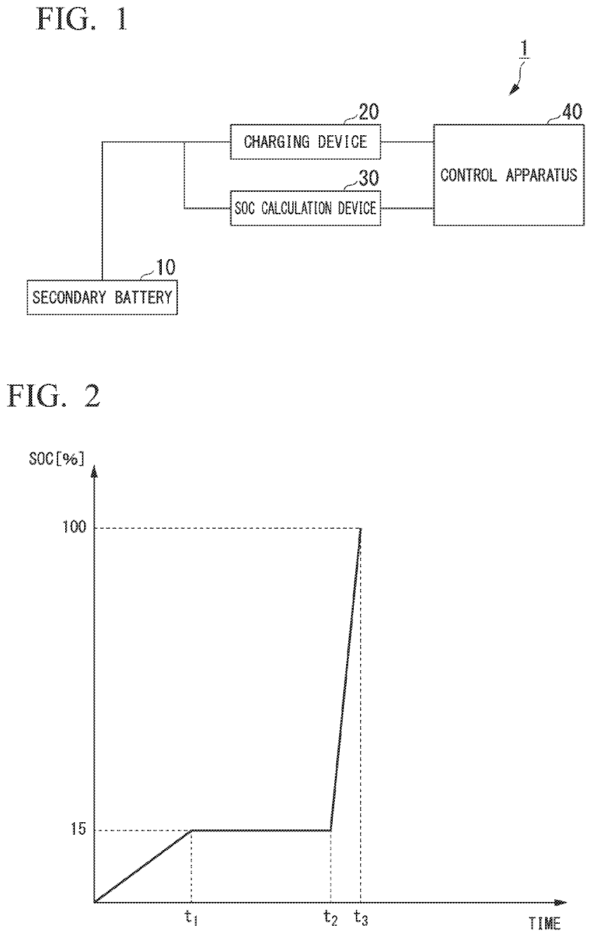

FIG. 2 is a view showing a transition example of the SOC of the secondary battery 10. The control apparatus 40 controls the magnitude of the current supplied to the secondary battery 10 by the charging device 20 to the first value when the SOC of the secondary battery 10 is less than 15%. When the SOC of the secondary battery 10 is 15% at a time t₁, the charging device 20 is controlled such that the charging device 20 does not supply the current to the secondary battery 10.

Then, the secondary battery 10 is stored in a state where the SOC is 15%. The secondary battery 10 may have a presentation portion that indicates whether or not the SOC is 15%, and may indicate whether or not the secondary battery 10 is in the state where the SOC is 15%.

At a time t₂, the control apparatus 40 controls the amount of electricity supplied to the secondary battery 10 by the charging device 20 to the second value. The time t₂ is a timing at which it is desired to make the SOC of the secondary battery 10 100%. The time t₂ is, for example, a timing at which a charging restart signal is input to the control apparatus 40. The control apparatus 40 includes, for example, a touch panel as an input device. For example, when the charging restart signal is input to the touch panel and the SOC of the secondary battery 10 is 15%, the control apparatus 40 controls the amount of electricity supplied to the secondary battery 10 by the charging device 20 to the second value.

The charging restart signal input to the control apparatus 40 may be a signal input to the secondary battery 10. For example, the secondary battery 10 is connected to the control apparatus 40 via the charging device 20. The secondary battery 10 includes, for example, a sensor as an input device and outputs the charging restart signal to the control apparatus 40 when the sensor detects a signal, and the control apparatus 40 controls the amount of electricity supplied to the secondary battery 10 by the charging device 20 to the second value when the SOC of the secondary battery 10 is 15%.

The time t₂ may be a preset time. The time t₂ is, for example, a time at which the use of the secondary battery 10 by a user is scheduled. The time t₂ is set, for example, by sending a signal having time information to the control apparatus 40.

The time t₂ may be a predetermined time after the time t₁. The control apparatus 40 may include a timer and may control the amount of electricity supplied to the secondary battery 10 to a second value after the predetermined time elapses after the charging device 20 is controlled not to supply a current to the secondary battery 10.

At a time t₃, the SOC of the secondary battery 10 is 100%, and the charging of the secondary battery 10 is completed. The control apparatus 40 controls the charging device 20 such that the charging device 20 does not supply the current to the secondary battery 10 when the SOC of the secondary battery 10 is 100%.

When the magnitude of a current that fully charges the rating capacity of the secondary battery 10 in one hour is 1C and is represented by a C rate, the first value which is the magnitude of the current supplied to the secondary battery 10 by the charging device 20 may be equal to or less than C/3, and the second value may be equal to or more than 2C. For example, when the rating capacity of the secondary battery 10 is 3Ah, the first value is equal to or less than 1A, and the second value is equal to or more than 6A. For example, when the first value is 0.2C, the second value can be preferably equal to or more than 10 times 0.2C which is the first value, such as 2.0C, 2.5C or 3.0C.

The progress of degradation is slower as the SOC of the secondary battery 10 is lower. However, it takes time to make the SOC 100% as the SOC is lower. Therefore, the value of the SOC when storing the secondary battery 10 is important. When the negative electrode is a mixture of SiO and graphite, the charging of graphite is performed by lithium ions being inserted between crystal layers of graphite, and the charging of SiO is performed by an alloying reaction of silicon and lithium. Accordingly, the charging reaction of SiO is a reaction having a larger resistance than that of graphite.

Further, the SiO is preferentially charged until the SOC reaches 15%. In the charging reaction, the SiO has a larger resistance than graphite, and a large charging current is less likely to flow. Therefore, the magnitude of the charging current can be preferably reduced at a SOC value of 0% to 15% in which the SiO is preferentially charged.

The negative electrode of the secondary battery 10 can be preferably a mixture of graphite and SiO rather than graphite alone. This is because the SiO has a larger specific capacity relative to the graphite, can thin the electrode, and can decrease an overvoltage when a current is applied.

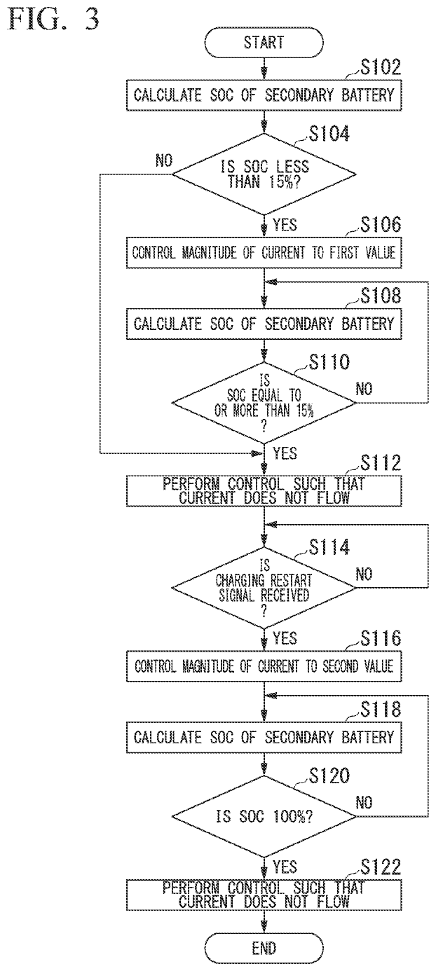

FIG. 3 is a flowchart showing an operation of the charging system 1. The SOC calculation device 30 calculates the SOC of the secondary battery 10 (Step S102). Next, the control apparatus 40 determines whether or not the SOC of the secondary battery 10 is less than 15% (Step S104). When the SOC is less than 15%, the control apparatus 40 controls the magnitude of the current supplied from the charging device 20 to the secondary battery 10 to the first value (Step S106). When the SOC is equal to or more than 15%, the charging system 1 performs an operation of Step S112 described later. Next, the SOC calculation device 30 calculates the SOC of the secondary battery (Step S108). Next, the control apparatus 40 determines whether or not the SOC of the secondary battery 10 is equal to or more than 15% (Step S110). When the SOC is equal to or more than 15%, the control apparatus 40 performs control such that the current does not flow from the charging device 20 to the secondary battery 10 (Step S112). When the SOC is less than 15%, the charging system 1 performs the operation of Step S108 again. Thereby, the control apparatus 40 monitors the SOC of the secondary battery 10.

Next, the control apparatus 40 determines whether or not the charging restart signal is received (Step S114). When the control apparatus 40 receives the charging restart signal, the control apparatus 40 controls the magnitude of the current supplied from the charging device 20 to the secondary battery 10 to the second value (Step S116). When the control apparatus 40 does not receive the charging restart signal, the operation of Step S114 is performed again. That is, the control apparatus 40 monitors that the charging restart signal is received.

Next, the SOC calculation device 30 calculates the SOC of the secondary battery (Step S118).

The control apparatus 40 determines whether or not the SOC of the secondary battery 10 is 100% (Step S120). When the SOC is 100%, the control apparatus 40 performs control such that the current does not flow from the charging device 20 to the secondary battery 10 (Step S122) and finishes the operation. When the SOC is not 100%, the charging system 1 performs the operation of Step S118 again. Thereby, the control apparatus 40 monitors the SOC of the secondary battery 10.

### Experimental Example

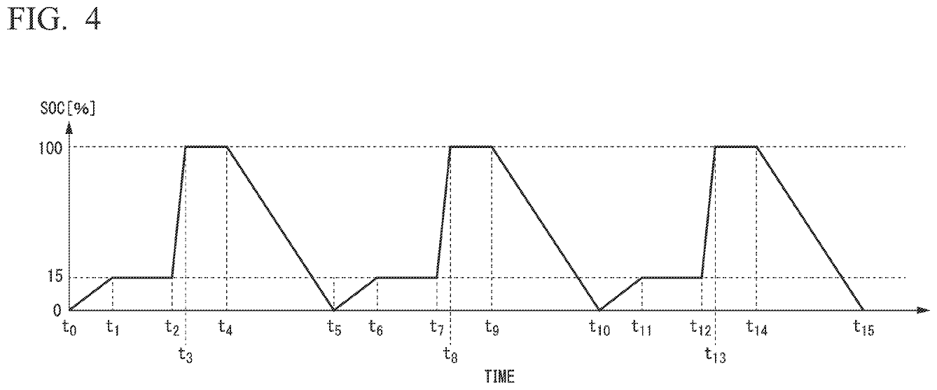

An experimental example is described. For comparison, a current supplied to the secondary battery 10 was controlled by two types of control methods, namely a control method of the embodiment of the present invention and a control method of the related art. FIG. 4 is a graph showing the control method of the embodiment of the present invention. The vertical axis represents the SOC of the secondary battery 10, and the horizontal axis represents time.

From a time t₀ to a time t₁, the magnitude of the current supplied to the secondary battery 10 by the charging device 20 is controlled to 0.2C. From the time t₁ to a time t₂, control is performed such that the charging device 20 does not supply the current to the secondary battery 10. Further, from the time t₁ to the time t₂, the secondary battery 10 is cooled such that the temperature of the secondary battery 10 is 0° C. From the time t₂ to a time t₃, the magnitude of the current supplied to the secondary battery 10 by the charging device 20 is controlled to 2.0C. From the time t₃ to a time t₄, control is performed such that the charging device 20 does not supply the current to the secondary battery 10. Further, from the time t₃ to the time t₄, the secondary battery 10 is warmed such that the temperature of the secondary battery 10 reaches room temperature. From the time t₄ to a time t₅, the secondary battery 10 discharges a current having a magnitude of 0.2C.

From the time t₅ to a time t₁₀ and from the time t₁₀ to a time t₁₅, the charging device 20 is controlled similarly to the time t₀ to the time t₅, but the magnitude of the current supplied to the secondary battery 10 by the charging device 20 from a time t₇ to a time t₈ and from a time t₁₂ to a time t₁₃ differs. From the time t₇ to the time t₈, the magnitude of the current supplied to the secondary battery 10 by the charging device 20 is controlled to 2.5C. From the time t₁₂ to the time tis, the magnitude of the current supplied to the secondary battery 10 by the charging device 20 is controlled to 3.0C.

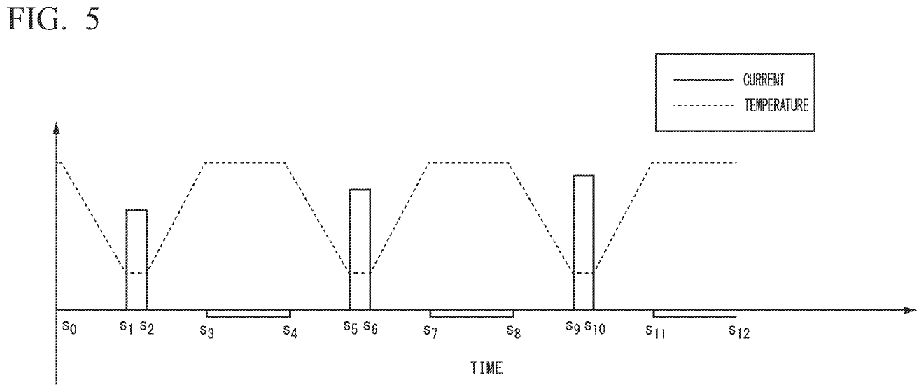

FIG. 5 is a graph showing the control method of the related art. From a time so to a time s₁, control is performed such that the charging device 20 does not supply the current to the secondary battery 10. Further, from the time so to the time s₁, the secondary battery 10 is cooled such that the temperature of the secondary battery 10 is 0° C. From the time s₁ to a time s₂, the magnitude of the current supplied to the secondary battery 10 by the charging device 20 is controlled to 2.0C. From the time s₂ to a time s₃, control is performed such that the charging device 20 does not supply the current to the secondary battery 10. Further, from the time s₂ to the time s₃, the secondary battery 10 is warmed such that the temperature of the secondary battery 10 reaches room temperature. From the time s₃ to a time s₄, the secondary battery 10 discharges a current having a magnitude of 0.2C.

From the time s₄ to a time s₈ and from the time s₈ to a time s₁₂, the temperature and the current supplied to the charging device 20 is controlled similarly to the time so to the time s₄, but the magnitude of the current supplied to the secondary battery 10 by the charging device 20 from a time s₅ to a time s₆ and from a time s₉ to a time s₁₀ differs. From the time s₅ to the time s₆, the magnitude of the current supplied to the secondary battery 10 by the charging device 20 is controlled to 2.5C. From the time s₉ to the time s₁₀, the magnitude of the current supplied to the secondary battery 10 by the charging device 20 is controlled to 3.0C.

Three types of combinations were employed as the combination of the positive electrode and the negative electrode of the secondary battery 10. The three types of combinations were NCM523/graphite (first battery), NCM622/graphite and SiO (second battery), and NCM811/graphite and SiO (third battery). In the second battery and the third battery, the negative electrode included SiO.

The magnitude of the current supplied to the secondary battery 10 and the type of the battery were changed, and the charging amount was measured.

The secondary battery 10 was discharged with a current of 0.05C having a small capacity loss due to the overvoltage in advance in a state where there is no battery degradation to thereby measure a capacity, and the measured capacity was set as a reference capacity (a 0.05C discharge capacity). In the present experiment, the control method of the charging device was evaluated according to the charging ratio that could be realized with respect to the reference capacity. In the present experiment, the secondary battery 10 was charged by controlling the charging device by the two control methods described above, this charging capacity was divided by the reference capacity, and thereby the charging amount (%) was calculated. After charging, the secondary battery 10 was discharged with a current of 0.2C, and the sequence was transferred to the next charging sequence.

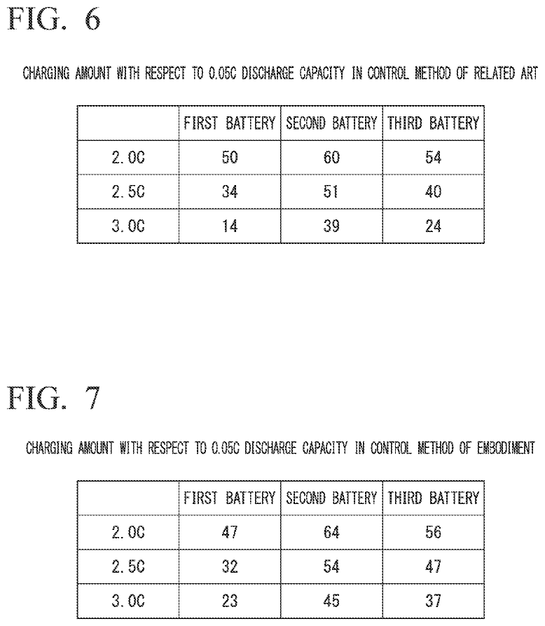

FIG. 6 is a view showing the charging amount in the control method of the related art. FIG. 7 is a view showing the charging amount in the control method of the embodiment of the present invention. In particular, in the second battery and the third battery in which the negative electrode included the SiO, the control method of the embodiment of the present invention was able to increase the charging amount of the secondary battery 10 compared to the control method of the related art.

According to the embodiment described above, the control apparatus 40 controls the magnitude of the current supplied to the secondary battery 10 to the first value until the SOC of the secondary battery 10 is 15%, and controls the magnitude of the current supplied to the secondary battery 10 to the second value that is larger than the first value when the SOC of the secondary battery 10 is equal to or more than 15%. Thereby, it is possible to obtain a higher charging amount.

The embodiment described above can be expressed as follows.

A control apparatus includes a storage device that stores a program, and a hardware processor, and is configured to control a magnitude of a current supplied to a secondary battery by a charging device which supplies a current to the secondary battery to a first value when it is determined that a SOC (State of Charge) of the secondary battery is equal to or less than 15%, and control the magnitude of the current supplied to the secondary battery by the charging device to a second value that is larger than the first value when a charging amount of the secondary battery is equal to or more than a first charging amount by the hardware processor executing the program stored in the storage device.

Although a mode for carrying out the present invention has been described using the embodiment, the present invention is not limited to the embodiment, and various modifications and substitutions can be made without departing from the scope of the present invention.

What is claimed is:

1. A control apparatus for controlling a charging device that is connected to a secondary battery having a negative electrode which is a mixture of graphite and silicon monoxide and supplies a current to the secondary battery,
wherein when a calculated SOC (State of Charge) of the secondary battery is less than 15%, a magnitude of the current supplied to the secondary battery by the charging device is controlled to a first value, and
when the calculated SOC of the secondary battery is equal to or more than 15%, the magnitude of the current supplied to the secondary battery by the charging device is controlled to a second value that is larger than the first value.

2. The control apparatus according to claim 1,
wherein when a magnitude of a current that charges a rating capacity of the secondary battery in one hour is set to 1C,
the first value is equal to or less than C/3, and
the second value is equal to or more than 2C.

3. A control method in which a computer controls a charging device that is connected to a secondary battery having a negative electrode which is a mixture of graphite and silicon monoxide and supplies a current to the secondary battery, the control method including:
controlling a magnitude of the current supplied to the secondary battery by the charging device to a first value when a calculated SOC (State of Charge) of the secondary battery is less than 15%; and
controlling the magnitude of the current supplied to the secondary battery by the charging device to a second value that is larger than the first value when the calculated SOC of the secondary battery is equal to or more than 15%.

4. A computer-readable non-transitory storage medium which includes a program causing a computer to control a charging device that is connected to a secondary battery having a negative electrode which is a mixture of graphite and silicon monoxide and supplies a current to the secondary battery, the program causing the computer to execute:
controlling a magnitude of the current supplied to the secondary battery by the charging device to a first value when a calculated SOC (State of Charge) of the secondary battery is less than 15%; and
controlling the magnitude of the current supplied to the secondary battery by the charging device to a second value that is larger than the first value when the calculated SOC of the secondary battery is equal to or more than 15%.
